(19) United States
(12) Patent Application Publication
(10) Pub. No.: US 2014/0280402 A1
(43) Pub. Date: Sep. 18, 2014

(54) COMPUTER IMPLEMENTED METHOD AND APPARATUS FOR SLICING ELECTRONIC CONTENT AND COMBINING INTO NEW COMBINATIONS

(71) Applicant: Early Access, Inc., Broomfield, CO (US)

(72) Inventors: Jill M. Tomich, Denver, CO (US); Ron L. Tomich, Denver, CO (US)

(73) Assignee: Early Access, Inc., Broomfield, CO (US)

(21) Appl. No.: 14/208,608

(22) Filed: Mar. 13, 2014

Related U.S. Application Data
(60) Provisional application No. 61/791,156, filed on Mar. 15, 2013.

(51) Int. Cl. G06F 17/30

(52) U.S. Cl. CPC G06F 17/30115
USPC 707/827

(57) ABSTRACT

Systems and methods for automatically splitting electronic content, for example, from books, magazines, journals, and other sources, to create new smaller ready-to-publish content parts, called slices, and recombining content parts from various sources to create new custom electronic book collections called Remixes. In a number of embodiments, content file splitting and custom book creation are automated so that it is easy for content owners of a reasonable technical skill level to quickly split existing electronic content files into ready-to-publish parts and to create custom ready-to-publish electronic content files composed of collections of existing content. In other embodiments, a member of the general public, end user, or consumer, can purchase those publisher-created parts and combine parts from various sources to create new custom electronic books.

### RELATED PATENT APPLICATIONS

This patent application claims priority to U.S. provisional patent application Ser. No. 61/791,156, filed on 15 Mar. 2013, titled: Software For Slicing Electronic Content And Combining Into New Combinations, which has the same inventors as the current patent application, and the contents of which is incorporated herein by reference.

### FIELD OF THE INVENTION

Embodiments of this invention relate to systems and methods for producing, managing, and distributing electronic content.

### BACKGROUND OF THE INVENTION

Publishers are generating increasing amounts of revenue from the sales of electronic content. The sale of electronic content avoids the costs of printing and distribution, and therefore opens up opportunities for selling portions of content extracted from existing content files like books, magazines and journals that have otherwise been out-of-print and are not available to world consumers. Most book publishers have hundreds and sometimes hundreds of thousands of previously published books, journals and magazines, which are commonly called “backlist” or “archived” content. If the content is available electronically, consumers interested in parts of any book or journal must either purchase the whole book or contact the publisher for permission to extract the parts they wish to buy. Publishers then manually extract those parts using a variety of unrelated tools.

The growth of electronic bookstores in the world has opened up new opportunities for sales of valuable parts of backlist content. But publishers must have the time, technical skills and resources required to figure out the steps needed to split existing electronic content and package it in a way that satisfies electronic content distribution requirements for publishing these new content parts and collections, all using existing tools not designed for this purpose. And publishers are limited to splitting files one by one manually.

Previously, for publishers or other users to split and recombine electronic content and attach required metadata to the new content in order to satisfy requirements for publishing this new content to electronic book stores, the publishers or other users had to have adequate technical skills, knowledge of unrelated content management tools, and invest much time and effort in order to accomplish these tasks, and it could only be done one file at a time. Publishers must also figure out how to recombine these individual parts into new custom collections that are fully prepared and packaged with the required metadata for publishing electronically. This process is also done manually and requires much time, effort and technical skill.

### SUMMARY OF PARTICULAR EMBODIMENTS OF THE INVENTION

This invention provides, among other things, computer implemented methods for extracting electronic content from existing sources to produce, manage, and distribute new combinations of that content. Various embodiments allow publishers to slice existing content into portions, combine the portions into new compilations based on instructions from customers or end users, and provide (e.g., sell) the new compilations to the end users or consumers. Some metadata can be retained from the original works while new metadata can also be added for the compilations in some embodiments. Various embodiments provide, for example, as an object or benefit, that they partially or fully address or satisfy one or more of the needs, potential areas for benefit, or opportunities for improvement described herein, or known in the art, as examples.

Specific embodiments of the invention provide various computer implemented methods of producing, managing, and distributing electronic content. In a number of embodiments, the method is implemented through machine-readable instructions that, if executed, perform, (e.g., in any order), at least the acts of splitting multiple existing electronic content files (e.g., each of the multiple existing electronic content files is split into multiple portions), receiving instructions from a user (e.g., identifying a selection of the multiple portions from multiple of the existing electronic content files), combining the selection (e.g., of the multiple portions) into a new customized electronic file, and transmitting the new customized electronic file to the user, for example, over a computer network. In some embodiments, for example, files are published to an online retail store.

In various embodiments, the multiple existing electronic content files each include text, the multiple portions each include text, and the new customized electronic file includes text. Further, in a number of embodiments, the multiple existing electronic content files include at least one electronic book, at least one magazine, or at least one journal, or a combination thereof. Further still, in some embodiments, the act of splitting multiple existing electronic content files includes retaining metadata details from the existing electronic content files. Even further, in particular embodiments, the metadata details include a title page, a title image, and an International Standard Book Number (ISBN) value. Even further still, certain embodiments include an act of adding new metadata details not found in the existing electronic content files. In particular embodiments, for example, the new metadata details include a title page, a title image, an ISBN value, a date, and a custom table of contents. Moreover, in some embodiments, the custom table of contents lists each of the multiple portions of the selection of the multiple portions.

In some embodiments, the electronic content files are processed in a batch processing operation. Moreover, in various embodiments, batch processing specifications for the batch processing operation are delivered through a graphical user interface or a web page interface, or through an electronic data interface, as examples. Further, in some embodiments, the user sends the instructions and receives the new customized electronic file with a mobile device or with a tablet device, for instance, having an Internet browser and Internet connectivity, as examples.

In other specific embodiments, the invention provides an apparatus for producing, managing, and distributing electronic content. In some embodiments, for example, the apparatus includes a splitter that splits existing electronic content files into multiple portions, an input module that receives instructions from users identifying selections of the multiple portions, an aggregator that combines the selections of the multiple portions into new customized electronic files, and an output module that transmits the new customized electronic files to the users over a computer network. In some embodiments, the apparatus further includes a collection module that collects payment from the users for the new customized electronic files.

In some embodiments of an apparatus, the existing electronic content files include at least one electronic book, at least one magazine, at least one journal, or a combination thereof, as examples. Further, in particular embodiments, the splitter retains metadata details from the existing electronic content files and the input module also adds new metadata details not found in the existing electronic content files. Still further, in various embodiments, the user sends the instructions and receives the new customized electronic file with a mobile device or with a tablet device, as examples, having an Internet browser and Internet connectivity.

In yet other specific embodiments, the invention provides an apparatus for producing, managing, and distributing electronic content, the apparatus including a means for splitting multiple existing electronic content files, wherein each of the multiple existing electronic content files is split into multiple portions; a means for receiving instructions from a user identifying a selection of the multiple portions from multiple of the existing electronic content files; a means for combining the selection of the multiple portions into a new customized electronic file; a means for transmitting the new customized electronic file to the user over a computer network; and a means for charging the user money for the new customized electronic file.

In addition, various other embodiments of the invention are also described herein, and other benefits of certain embodiments may be apparent to a person of ordinary skill in the art.

### BRIEF DESCRIPTION OF THE DRAWINGS

FIG. 1 is a front view of an example of a computer that, if appropriately programmed, can be used to implement or can form various embodiments of the invention;

FIG. 2 is a block diagram illustrating an example of elements contained within the computer of FIG. 1;

FIG. 3 is a flow chart illustrating an example of a method of producing, managing, and distributing electronic content; and

FIG. 4 is a block diagram illustrating an example of an apparatus for producing, managing, and distributing electronic content.

These drawings illustrate, among other things, examples of embodiments and certain aspects of particular embodiments of the invention. Other embodiments may differ. Various embodiments may include aspects shown in the drawings, described in the specification, shown or described in other documents that are incorporated by reference, known in the art, or a combination thereof, as examples.

### DETAILED DESCRIPTION OF EXAMPLES OF EMBODIMENTS

This patent application describes, among other things, examples of certain embodiments, and certain aspects thereof. Other embodiments may differ from the particular examples described in detail herein. In a number of embodiments an Internet-based software system or method can be used by a user (e.g., at a lower technical skill level than required by prior software systems) to automatically split electronic content files of various file sizes, such as books, magazines and journals, to automatically create new, smaller and ready-to-publish content parts (Slices). As used herein, unless indicated otherwise, “ready-to-publish” means fully packaged with all necessary metadata, cover image, and copyright information in order to sell it (the slice or slices) on eBook stores. Secondly, in many embodiments, the system or method can be used to recombine or aggregate a number of content files from a number of file sources simultaneously to create new ready-to-publish custom collections of content (Remixes).

In some embodiments, both the parts split from the content and the new aggregate content contain commonly required publishing metadata extracted from the original content. Further, in particular embodiments, the user can add additional metadata, for instance, using included system tools. Even further, in different embodiments, the system or method can process one content file at a time, or can process multiple content files in a single batch operation. Moreover, in certain embodiments, the tools and modules that make up the system are found on a website and are accessed via the Internet. The system can be accessed, in a number of embodiments, with a multi-purpose computer, mobile device or tablet device, for example, together with an Internet browser with Internet connectivity.

In various embodiments, the system automates the process of splitting content files, such as electronic books, magazines and journals, or a sub-combination thereof, into ready-to-publish portions as defined by the user, such as chapters, articles, sections, or pages. Further, in particular embodiments, the system automates the process of aggregating content parts as selected by the user from various other electronic content, such as books, magazines, or journals, to create new ready-to-publish customized electronic files. Even further, in a number of embodiments, the splitting operation can be used to retain original publishing metadata details from the source files or to replace certain data as specified. Examples of replaceable data include title pages, title images, dates, ISBN values, category assignment, territory restrictions, and content description. Even further still, in some embodiments, the aggregating operation can be used to retain original publishing metadata or to replace certain data as specified. Examples of replaceable data include title pages, title images, dates, ISBN values, category assignment, territory restrictions, and content description. In addition, a custom table of contents can be automatically generated for a new book file in some embodiments. Still further, in different embodiments, the system can process single files individually, or can process multiple content files in a single batch processing operation. The batch processing specifications can be delivered to the system in different ways, in different embodiments, including through the use of a graphical user interface or a web page interface, or through an electronic data interface (EDI), as examples. In a number of embodiments, an EDI can include, for example, spreadsheets, text, or other data transfer methods, for instance. Moreover, in various embodiments, users can access the system with a typical computer, mobile device or tablet device, for example, that has an Internet browser and Internet connectivity.

In a number of embodiments, the first part of the operation, which we call Slicing, enables a content owner, such as a publisher, for example, to split existing electronic content such as books, magazines, and journals, or a sub-combination thereof, for instance, into user defined parts. These parts can be packaged with required metadata, in various embodiments, that allows the new individual parts to be published, for example, to existing electronic book marketplaces as new stand-alone products.

In a particular example, to slice content files, the publisher follows a five-step online process using Slicing Workflow, as described in the following paragraphs. In a number of embodiments, whole electronic files such as books, magazines, and journals, or a sub-combination thereof, are sliced to create new ready-to-publish content parts (Slicing). In this example, content owners follow the following five steps in order to create new electronic content by splitting existing content files. In different embodiments, content can be uploaded and split one file at a time or in batches of multiple files.

In a first slicing step of this example, the publisher, for example, uploads existing content to the system using a computer, mobile device or tablet device together with an Internet browser with Internet connectivity. The publisher can upload, in some embodiments, multiple files, for example, in the ePub or PDF formats. Some embodiments provide for either such format. In some embodiments, the publisher can click on files in one region and drag them to a second region, for example, to identify which files to upload.

In a second slicing step of this particular example, the system analyzes each uploaded file and defines which parts are available to be sliced, which are called Slice Levels. Publishers can click on and choose from up to three Slice Levels, in some embodiments. For example, in certain embodiments, Level One is the section level, Level Two is the chapter level, and Level Three is the sub-chapter level. Other embodiments can have other numbers of Slice Levels (e.g., 1, 2, 4, 5, 6, 7, 8, 9, 10, or 12 slice levels), can allocate the Slice Levels differently, or both, as other examples. In addition, in this example, the publisher can define which slices are front matter and which are back matter. In this example, this information will enable the user to assign front and back matter to a given (e.g., any given) slice in a third step.

In the third step of this particular example, the publisher selects what parts of the front and back matter of the book can be attached to an (e.g., any) individual slice. For example, the user may want to attach the Table of Contents to each slice, and/or the Introduction, and/or the Index, and so on. In a number of embodiments, the publisher can select parts by clicking on an icon or button for that part, for example. In a fourth slicing step of this example, the publisher can customize the covers of each slice. This is done, in some embodiments, by using an included Color Wheel to select or customize the background banner cover, for example. In a fifth slicing step of this particular example, the publisher reviews the choices that have been made, and if satisfied, initiates the slicing process. In a number of embodiments, each slice is then compiled and packaged, for example, as a stand-alone digital product.

In various embodiments, ISBN values can be assigned based on several different algorithms, such as the original book ISBN, custom ISBNs from a spreadsheet, or by appending onto the original ISBN, as examples. The result of the batch splitting operation, in a number of embodiments, is a collection of individual book part files that may be each independently published and sold as new electronic book products, for example.

In a remixing process, a user can recombine or remix selected parts to create one or more new user-customized electronic books, for example. In a number of embodiments, the system or method enables publishers to recombine individual content parts from an unlimited number of sources to create a new customized electronic book. In particular embodiments, this is done in a 4-step online workflow. In one example, in a first step, the publisher chooses or selects content slices to include in the new Remix. This is done, in some embodiments, by dragging and dropping content slices from the left column to the right column, for example. The user can then rearrange the order of the slices, in certain embodiments, by dragging them up or down. In a second remix step of this particular example, the publisher can either design a new, custom book cover for the new Remixed ebook by using one of several available templates, or by uploading their own cover. Other embodiments can offer just one of these options, other options, or both. In some embodiments, the publisher can select color of the cover, among other things. In a third remix step of this example, the publisher can assign and edit metadata to the new digital product, in a number of embodiments, by using the available metadata fields. At a fourth remix step in this example, the publisher can review all choices made so far and then either initiate the Remix or revise choices, for example, by using the “Back” button.

On average, in certain embodiments, it usually takes less than a minute to compile and package individual content parts into the new, ready-to-publish digital product. Further, in some embodiments, at completion, the user can edit the metadata further, publish the Remix to various ebook retail stores, download the file to their own network, or a combination thereof, as examples. Even further, in some embodiments, a user can transfer files offline (on a flash drive or disk, for example), rather than via a network such as the Internet, and the slicing can happen offline, for example, on a desktop computer.

FIG. 1 illustrates an exemplary embodiment of computer system 600, all of which or a portion of which can be suitable for implementing various techniques described herein. As an example, a different or separate one of chassis 602 (and its internal components) can be suitable for implementing certain techniques described herein. Furthermore, one or more elements of computer system 600 (e.g., refreshing monitor 606, keyboard 604, and/or mouse 610, etc.) can also be appropriate for implementing particular techniques described herein. Computer system 600 comprises chassis 602 containing one or more circuit boards, Universal Serial Bus (USB) port 612, Compact Disc Read-Only Memory (CD-ROM) and/or Digital Video Disc (DVD) drive 616, and hard drive 614. A representative block diagram of the elements included on the circuit boards inside chassis 602 is shown in FIG. 2. Central processing unit (CPU) 710 in FIG. 2 is coupled to system bus 714 in FIG. 2. In various embodiments, the architecture of CPU 710 can be compliant with one or more of a variety of commercially distributed architecture families.

Continuing with FIG. 2, system bus 714 is also coupled to memory storage unit 708, where memory storage unit 708 comprises, in this example, both read only memory (ROM) and random access memory (RAM). Non-volatile portions of memory storage unit 708 or the ROM can be encoded with a boot code sequence suitable for restoring computer system 600 (FIG. 1) to a functional state after a system reset. In addition, memory storage unit 708 can comprise microcode such as a Basic Input-Output System (BIOS). In some examples, the one or more memory storage units of the various embodiments disclosed herein can comprise memory storage unit 708, a USB-equipped electronic device, such as, an external memory storage unit coupled to universal serial bus (USB) port 612 (FIGS. 1-2), hard drive 614 (FIGS. 1-2), and/or CD-ROM or DVD drive 616 (FIGS. 1-2). In the same or different examples, the one or more memory storage units of the various embodiments disclosed herein can comprise an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Some examples of common operating systems can comprise Microsoft® Windows® operating system (OS), Mac® OS, UNIX® OS, and Linux® OS.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or another type of processor or processing circuit capable of performing the desired functions. In some examples, the one or more processors of the various embodiments disclosed herein can comprise CPU 710.

In the embodiment depicted in FIG. 2, various I/O devices such as disk controller 704, graphics adapter 724, video controller 702, keyboard adapter 726, mouse adapter 706, network adapter 720, and other I/O devices 722 can be coupled to system bus 714. Keyboard adapter 726 and mouse adapter 706 are coupled to keyboard 604 (FIGS. 1-2) and mouse 610 (FIGS. 1-2), respectively, of computer system 600 (FIG. 1). While graphics adapter 724 and video controller 702 are indicated as distinct units in FIG. 2, video controller 702 can be integrated into graphics adapter 724, or vice versa in other embodiments. Video controller 702 is suitable for refreshing monitor 606 (FIGS. 1-2) to display images on a screen 608 (FIG. 1) of computer system 600 (FIG. 1). Disk controller 704 can control hard drive 614 (FIGS. 1-2), USB port 612 (FIGS. 1-2), and CD-ROM drive 616 (FIGS. 1-2). In other embodiments, distinct units can be used to control each of these devices separately.

In some embodiments, network adapter 720 can comprise and/or be implemented as a WNIC (wireless network interface controller) card plugged or coupled to an expansion port in computer system 600 (FIG. 1). In other embodiments, the WNIC card can be a wireless network card built into computer system 600 (FIG. 1). A wireless network adapter can be built into computer system 600 by having wireless communication capabilities integrated into the motherboard chipset, or implemented via one or more dedicated wireless communication chips, connected through a PCI (peripheral component interconnector) or a PCI express bus of computer system 600 (FIG. 1) or USB port 612 (FIG. 1). In other embodiments, network adapter 720 can comprise and/or be implemented as a wired network interface controller card. Other components of computer system 600 (FIG. 1) and their interconnection are well known to those of ordinary skill in the art.

When computer system 600 in FIG. 1 is running, program instructions stored on a USB-equipped electronic device connected to USB port 612, on a CD-ROM or DVD in CD-ROM and/or DVD drive 616, on hard drive 614, or in memory storage unit 708 (FIG. 2) are executed by CPU 710 (FIG. 2). A portion of the program instructions, stored on these devices, can be suitable for carrying out at least part of the techniques described herein.

Although computer system 600 is illustrated as a desktop computer in FIG. 1, there can be examples where computer system 600 may take a different form while still having functional elements similar to those described for computer system 600. In some embodiments, computer system 600 may comprise a single computer, a single server, or a cluster or collection of computers or servers, or a cloud of computers or servers, as examples. Typically, a cluster or collection of servers can be used when the demand on computer system 600 exceeds the reasonable capability of a single server or computer.

Various embodiments include computer implemented methods of producing, managing, and distributing electronic content. FIG. 3 illustrates an example of such a method, method 300. Such a method can include, or be implemented using, for example, machine-readable instructions that, if executed, perform, (e.g., in any order), at least certain acts. Examples of such acts are described herein. Where acts are shown or described in a particular order herein, the order presented is an example of an order that the acts can be performed in, but in different embodiments, unless stated otherwise or not logically possible, the acts can be performed in a different order. In some embodiments, for instance, certain acts or a combination of acts can overlap or be performed at the same time, as examples.

Method 300 shown in FIG. 3 includes act 301 of splitting existing electronic content files, for example, splitting multiple existing electronic content files. In some embodiments, each of the multiple existing electronic content files is split into multiple portions, for instance. Method 300 also includes act 302 of receiving instructions (e.g., from a user) identifying a selection, for example, of the multiple portions, for instance, from multiple of the existing electronic content files. Method 300 further includes act 303 of combining the selection (e.g., of the multiple portions), into a new customized electronic file. Further, method 300 includes act 306 of transmitting the new customized electronic file, for instance, to the user, for example, over at least one network, such as a computer network. Different embodiments can include some or all of these acts, for example. Some embodiments include other acts as well.

In some embodiments, the multiple existing electronic content files (e.g., split in act 301) each include text, the multiple portions (e.g., formed in act 301) each include text, the new customized electronic file (e.g., formed in act 303) includes text, or a combination thereof. Further, in the embodiment shown, method 300 illustrated in FIG. 3 includes, for example, act 305 of obtaining payment or charging the user money, for instance, for the new customized electronic file (e.g., transmitted in act 306). Still further, in various embodiments, the multiple existing electronic content files (e.g., split in act 301) include at least one electronic book, at least one magazine, at least one journal, or a combination thereof, as examples. Even further, in some embodiments, act 301, for example, of splitting multiple existing electronic content files, includes retaining (e.g., in, or associated with, the portions or slices) metadata details from the existing electronic content files. Even further still, in various embodiments, the metadata details include a title page, a title image, an ISBN value, or a combination thereof, as examples.

Moreover, in the embodiment illustrated, method 300 includes, for example, act 304 of adding new metadata details, for instance, not found in the existing electronic content files (e.g., that were split in act 301). In various embodiments, the new metadata details (e.g., added in act 304) include a title page, a title image, an ISBN value, a date, a custom table of contents, or a combination thereof, as examples. In particular embodiments, the custom table of contents (e.g., added in act 304) lists each of the multiple portions of the selection of the multiple portions (e.g., identified in act 302), for instance.

In a number of embodiments, the electronic content files (e.g., spit in act 301) are processed individually. In other embodiments, however, the electronic content files are processed in a batch processing operation. In various embodiments, as examples, batch processing specifications for the batch processing operation are delivered through a graphical user interface, through a web page interface, through an EDI or a spreadsheet, or a combination thereof, as examples. Further, in a number of embodiments, the computer network is the Internet, for example, the user sends the instructions (e.g., received in act 302) and receives the new customized electronic file (e.g., transmitted in act 306) with a mobile device, with a tablet device having an Internet browser and Internet connectivity, or a combination thereof, for instance.

In the embodiment illustrated and described, method 300 shown in FIG. 3 is tied to a particular machine or apparatus. In particular, method 300 is a computer implemented method, and is tied to one or more computers. Further, the one or more computers constitutes a “particular machine” because the one or more computers is specifically programed with machine-readable instructions that perform a combination or sub-combination of the specific acts recited. Furthermore, in the embodiment depicted, method 300 transforms a particular article into a different state or thing. Specifically, method 300 splits electronic content files into multiple portions or slices. In addition, method 300 combines the portions into (e.g., one or more) new customized electronic files. In this manner, method 300 transforms articles, such as books, magazines, and journals, or a sub-combination thereof, into a different state or thing, for example, into electronic files or e-books that contain new combinations of content. Thus, method 300, in the embodiment illustrated, is both tied to a particular machine or apparatus, and is transformative. This would be apparent to a person of ordinary skill in the art.

Further, various embodiments include different structure, systems, or apparatuses, for example, for producing, managing, and distributing electronic content. FIG. 4 illustrates an example of such a structure, system, or apparatus, apparatus 400. In the embodiment illustrated, for example, apparatus 400 includes, for example, splitter 410 that splits existing electronic content files into multiple portions (e.g., act 301 shown in FIG. 3), input module 430 that receives instructions from users identifying selections of the multiple portions (e.g., act 302), aggregator 420 that combines the selections of the multiple portions into new customized electronic files (e.g., act 303), output module 440 that transmits the new customized electronic files to the users (e.g., act 306), for example, over network 470, or a combination thereof, as examples. In a number of embodiments, the existing electronic content files (e.g., split in splitter 410) each include text, the multiple portions (e.g., aggregated in aggregator 420) each include text, and the new customized electronic files (e.g., output through output module 440) each includes text, or a sub-combination thereof.

Still further, some embodiments include for example, a payment module or collection module that collects payment (e.g., act 305) from the users for the new customized electronic files (e.g., output through output module 440). Apparatus 400, for example, includes collection module 460. Moreover, in the embodiment illustrated, the source files or existing electronic content files (e.g., available to be split by splitter 410) are stored in database 450 and include at least one electronic book (e.g., book 452 shown), include at least one magazine (e.g., magazine 454 shown), and include at least one journal (e.g., 456 shown). Different embodiments include a combination or sub-combination thereof. Electronic books (e.g., book 452), electronic magazines (e.g., magazine 454), and electronic journals (e.g., 456), are examples of electronic files (e.g., stored within database 450). In various embodiments, electronic files include PDF files, ePub files, or both, as examples. Further, a number of embodiments (e.g., of apparatus 400) are configured to slice and combine (e.g., via splitter 410 and aggregator 420) both formats of PDF files and ePub files. Further a number of embodiments are described herein wherein the electronic files include text. In various embodiments, however, the electronic content (e.g., in database 450), the slices (e.g., created by splitter 410, or both, include graphic images (e.g., in addition to text or instead).

Even further, in some embodiments, the splitter (e.g., 410), for example, retains metadata details from the existing electronic content files (e.g., in database 450). Such metadata details can include, for example, a title page, a title image, an ISBN value, or a combination thereof. Even further still, in some embodiments, the input module (e.g., 430), for instance, adds new metadata details, for example, not found in the existing electronic content files (e.g., as described for act 304). Moreover, in particular embodiments, the new metadata details include a title page, a title image, an ISBN value, a date, a custom table of contents, or a combination thereof, as examples. In certain embodiments, the custom table of contents lists each of the multiple portions of the selection of the multiple portions or slices, for example.

In different embodiments of such an apparatus (e.g., 400), the electronic content files (e.g., stored within database 450, split with splitter 410, or both) can be processed (e.g., by apparatus 400, or specifically by splitter 410, aggregator 420, or both) individually, or can be processed in a batch processing operation, as examples. In some embodiments, for instance, batch processing specifications for the batch processing operation are delivered through a graphical user interface or a web page interface (e.g., via network 470), through an EDI or a spreadsheet, or a combination thereof, as examples. In a number of embodiments, network 470 is a computer network such as the Internet, for example, the user sends the instructions and receives the new customized electronic file with a computer (e.g., 480), the user sends the instructions and receives the new customized electronic file with a mobile device (e.g., 482), the user sends the instructions and receives the new customized electronic file with a tablet device (e.g., 484), for example, having an Internet browser and Internet connectivity, or a combination thereof. In the embodiment illustrated, computer 480 can be a general purpose computer or a personal computer, for example, such as a desktop computer (e.g., computer system 600 shown in FIG. 1) or a laptop computer, as examples. Further, in the embodiment illustrated, mobile device 482 can be a smart phone, and network 470 can include, or mobile device 482 can connect to network 470 with, a mobile phone network, for example.

Moreover, in particular embodiments, an apparatus for producing, managing, and distributing electronic content (e.g., 400) can include, for example, a means for splitting multiple existing electronic content files wherein each of the multiple existing electronic content files is split into multiple portions. In the embodiment illustrated, splitter 410 is an example of such a means for splitting. Further, in a number of embodiments, an apparatus for producing, managing, and distributing electronic content (e.g., 400) can include, for example, a means for receiving instructions from a user identifying a selection of the multiple portions from multiple of the existing electronic content files. In the embodiment illustrated, input module 430 is an example of such a means for receiving instructions. Further still, in some embodiments, an apparatus for producing, managing, and distributing electronic content (e.g., 400) can include, for example, a means for combining the selection of the multiple portions into a new customized electronic file. In the embodiment illustrated, aggregator 420 is an example of such a means for combining. Even further, in various embodiments, an apparatus for producing, managing, and distributing electronic content (e.g., 400) can include, for example, a means for transmitting the new customized electronic file to the user over a computer network. In the embodiment illustrated, output module 440 is an example of such a means for transmitting. Even further still, in certain embodiments, such an apparatus can include, for example, an apparatus for producing, managing, and distributing electronic content (e.g., 400) can include, for example, a means for charging the user (e.g., money) for the new customized electronic file. In the embodiment illustrated, collection module 460 is an example of such a means for charging.

In various embodiments, apparatus 400 can be or include a machine, such as one or more computers or servers, as examples. Computer 600 shown in FIG. 1 is an example. In some embodiments, apparatus 400 includes multiple computers or servers, which can be in different locations in certain embodiments. In some embodiments, for example, database 450 can be located, in whole or in part, within memory storage unit 708 shown in FIG. 2 of computer system 600 shown in FIG. 1. In other embodiments, however, database 450 can be remotely located from the remainder of apparatus 400, or from computer 600, for example, or can include multiple databases at multiple locations, for instance.

In various embodiments, apparatus 400 includes software or machine-readable instructions, that, when executed, perform certain functions, for example, described herein. In some embodiments, apparatus 400 includes one or more general purpose computers (e.g., computer system 600) or serves, for example, and the software or machine-readable instructions provide the novel and unique characteristics of the invention or embodiment. In the embodiment illustrated, splitter 410, aggregator 420 and modules 430, 440, and 460 can be formed by or within the software or machine-readable instructions, for example. Further, although splitter 410, aggregator 420 and modules 430, 440, and 460 are shown as discrete items in FIG. 4, these items are not necessarily discrete portions of code within the software or machine-readable instructions. On the other hand, in some embodiments, one or more of splitter 410, aggregator 420 and modules 430, 440, and 460, can be formed by multiple discrete portions of software, for example, operating on the same or different machines. Further still, while input module 430 and output module 440 are shown connected to network 470 with arrows that have a single arrow head, it should be understood that, to at least some extent, two-way communication can exist through these modules or through network 470, for example, to establish links to provide the flow of data that these modules primarily perform. Further, in the embodiment illustrated, apparatus 400 communicates with one or more users through network 470 and user devices such as devices 480, 482, and 484, which are also connected to or in communication with, network 470, either directly or through one or more other networks.

Some embodiments provide electronic content slicing, for example, for publishers and content owners. Existing content can be repurposed to create new digital products. In a number of embodiments, these new digital products are fully packaged digital products that include metadata, a cover, and a copyright page, for example. In various embodiments, these new digital products are ready-to-publish content slices. Some embodiments, however, provide a remixing service, for example, for publishers (e.g., only), for instance, as described herein. Still other embodiments provide a remixing web widget, for example, for use by users or consumers. In some embodiments, such a web widget can be embedded on (e.g., multiple) web sites. In some such embodiments, consumers cannot attach metadata. In a number of embodiments, however, consumers can add a title and a description to their remix. In a number of such embodiments, however, the consumer cannot resell such a remix. In certain embodiments, an embeddable web widget can be copied and pasted onto a website (e.g., virtually any typical website) to offer custom remixing to that site's audience, for example. Thus, in different embodiments, there are two types of remix tools. One type goes on a website controlled by the owner of the remix tool, and the other type remix tool is the embeddable web widget that can be copied and pasted onto an unlimited number of websites.

Moreover, a number of embodiments are described herein wherein one or more publishers are specifically identified. In other embodiments, instead of a publisher, another entity or person, such as a member of the general public, end user, or consumer, can be substituted for the publisher. For example, in some embodiments, a consumer can perform or initiate the combining, remixing, or other acts or steps described herein (e.g., acts 301 and 303 shown in FIG. 3), for example, using software, a web page, or a web widget, as examples (e.g., part or all of apparatus 400 shown in FIG. 4). In certain embodiments, for example, the consumer can perform one of more such tasks using a mobile device (e.g., 482) or tablet (e.g., 484), for example. In various embodiments, however, only content owners can slice content.

Various embodiments of the subject matter described herein include various combinations of the acts, structure, components, and features described herein, shown in the drawings, or that are known in the art. Moreover, certain procedures can include acts such as manufacturing, obtaining, or providing components or software that perform functions described herein or in the documents that are incorporated by reference. Furthermore, various embodiments include advertising and selling products that perform functions described herein, that contain structure described herein, or that include instructions to perform functions described herein, as examples. Such products may be obtained or provided through distributors, dealers, or over the Internet, for instance. The subject matter described herein also includes various means for accomplishing the various functions or acts described herein, in the documents that are incorporated by reference, or that are apparent from the structure and acts described.

Further, as used herein, the word “or”, except where indicated otherwise, does not imply that the alternatives listed are mutually exclusive. Even further, where alternatives are listed herein, it should be understood that in some embodiments, fewer alternatives may be available, or in particular embodiments, just one alternative may be available, as examples.

What is claimed is:

1. A computer implemented method of producing, managing, and distributing electronic content, the method comprising machine-readable instructions that, if executed, perform, in any order, at least the acts of:
splitting multiple existing electronic content files wherein each of the multiple existing electronic content files is split into multiple portions;
receiving instructions from a user identifying a selection of the multiple portions from multiple of the existing electronic content files;
combining the selection of the multiple portions into a new customized electronic file; and
transmitting the new customized electronic file to the user over a computer network.

2. The method of claim 1 wherein the multiple existing electronic content files each comprise text, the multiple portions each comprise text, and the new customized electronic file comprises text.

3. The method of claim 1 wherein the multiple existing electronic content files include at least one electronic book, at least one magazine, or at least one journal.

4. The method of claim 1 wherein the act of splitting multiple existing electronic content files comprises retaining metadata details from the existing electronic content files.

5. The method of claim 4 wherein the metadata details include a title page, a title image, and an ISBN value.

6. The method of claim 1 further comprising an act of adding new metadata details not found in the existing electronic content files.

7. The method of claim 6 wherein the new metadata details include a title page, a title image, an ISBN value, a date, and a custom table of contents.

8. The method of claim 7 wherein the custom table of contents lists each of the multiple portions of the selection of the multiple portions.

9. The method of claim 1 wherein the electronic content files are processed in a batch processing operation.

10. The method of claim 9 wherein batch processing specifications for the batch processing operation are delivered through a graphical user interface.

11. The method of claim 9 wherein batch processing specifications for the batch processing operation are delivered through a web page interface.

12. The method of claim 9 wherein batch processing specifications for the batch processing operation are delivered through an electronic data interface.

13. The method of claim 1 wherein the user sends the instructions and receives the new customized electronic file with a mobile device.

14. The method of claim 1 wherein the user sends the instructions and receives the new customized electronic file with a tablet device having an Internet browser and Internet connectivity.

15. An apparatus for producing, managing, and distributing electronic content, the apparatus comprising:
a splitter that splits existing electronic content files into multiple portions;
an input module that receives instructions from users identifying selections of the multiple portions;
an aggregator that combines the selections of the multiple portions into new customized electronic files; and
an output module that transmits the new customized electronic files to the users over a computer network.

16. The apparatus of claim 15 further comprising a collection module that collects payment from the users for the new customized electronic files.

17. The apparatus of claim 15 wherein the existing electronic content files include at least one electronic book, at least one magazine, or at least one journal.

18. The apparatus of claim 15 wherein the splitter retains metadata details from the existing electronic content files and wherein the input module adds new metadata details not found in the existing electronic content files.

19. The apparatus of claim 15 wherein the user sends the instructions and receives the new customized electronic file with a mobile device or with a tablet device having an Internet browser and Internet connectivity.

20. An apparatus for producing, managing, and distributing electronic content, the apparatus comprising:
a means for splitting multiple existing electronic content files wherein each of the multiple existing electronic content files is split into multiple portions;
a means for receiving instructions from a user identifying a selection of the multiple portions from multiple of the existing electronic content files;
a means for combining the selection of the multiple portions into a new customized electronic file;
a means for transmitting the new customized electronic file to the user over a computer network; and
a means for charging the user money for the new customized electronic file.
